(19) United States
(12) Patent Application Publication
(10) Pub. No.: US 2021/0334683 A1
(43) Pub. Date: Oct. 28, 2021

(54) Method for predicting an operating duration of a connected object

(71) Applicant: ORANGE, Paris (FR)

(72) Inventor: David Excoffier, Chatillon Cedex (FR)

(21) Appl. No.: 17/237,551

(22) Filed: Apr. 22, 2021

(30) Foreign Application Priority Data
Apr. 22, 2020 (FR) 2004027

(51) Int. Cl. G06N 5/04

(52) U.S. Cl. CPC G06N 5/04

(57) ABSTRACT

A method for predicting an operating duration of a connected object. The method includes: obtaining an amount of instantaneous energy consumed by the connected object; obtaining at least one amount of instantaneous energy dependent on an ambient energy, and able to be used to supply the connected object; obtaining a remaining service life of the connected object on the basis of the amounts; obtaining the predicted operating duration of the connected object on the basis of the remaining service life; and performing at least one action taking into account the predicted operating duration.

### FIELD OF THE DISCLOSURE

The present disclosure relates to the general field of connected objects, and more particularly to that of managing the energy consumption of such objects.

### BACKGROUND OF THE DISCLOSURE

Connected objects are nowadays being increasingly used.

Some of these objects have relatively limited processing capabilities and autonomy.

They may be used to perform highly varied tasks that are more or less critical and consume more or less computing power or energy. Some of them may have more or less constant operation, others may have more or less regular operation, and others may have highly irregular operation.

For example, a connected object may be used to perform occasional cryptographic operations and to regularly relay measurements delivered by a sensor.

Some of these connected objects may be supplied by the electricity grid, or run at least temporarily off a battery. Some of them may also produce energy from a renewable energy source. For some renewable energies, the amount of energy able to be produced at a given time may vary greatly over time, and do so in a more or less predictable manner.

In this highly uncertain environment, it is conventional to overdimension either the energy production capacities of these connected objects (solar panels, wind power generators, etc.) or their energy storage capacities (batteries) so as to decrease the risk of an energy failure of the connected object.

This solution might not be satisfactory for some connected objects. The invention targets a solution that avoids such overdimensioning.

### SUMMARY

According to a first aspect, an exemplary embodiment of the invention relates to a method for predicting an operating duration of a connected object, the method comprising:
a step of obtaining an amount of instantaneous energy consumed by the connected object;
a step of obtaining at least one amount of instantaneous energy, dependent on an ambient energy, and able to be used to supply the connected object;
a step of obtaining a remaining service life of the connected object on the basis of these amounts;
a step of obtaining the predicted operating duration of the connected object on the basis of the remaining service life; and
a step of performing at least one action taking into account this predicted operating duration.

In correlation, an exemplary embodiment of the invention relates to a connected object comprising:
a module for obtaining an amount of instantaneous energy consumed by the connected object;
a module for obtaining at least one amount of instantaneous energy dependent on an ambient energy and able to be used to supply the connected object;
a module for obtaining a remaining service life of the connected object on the basis of these amounts;
a module for obtaining a predicted operating duration of the connected object on the basis of said remaining service life; and
a module for performing at least one action taking into account said predicted operating duration.

In one particular embodiment, the connected object comprises a battery.

Thus, and generally speaking, an exemplary embodiment of the invention proposes a method that makes it possible to predict an operating duration of a connected object and to perform an action on the basis of this prediction. This operating duration makes it possible to predict a time of failure of the connected object, in particular caused by a lack of energy supply.

The proposed prediction method comprises a step of obtaining an amount of instantaneous energy that is able to be used directly or indirectly to supply the connected object. This energy may be:
either energy produced by an energy production module of the connected object from the ambient energy;
or the ambient energy itself.

The service life of the connected object is thus estimated by taking into account either the ambient energy itself or the amount of energy able to be produced by the connected object from the ambient energy. The service life of the connected object is thus estimated accurately, even though the renewable energy source exhibits strong variations over time, for example if the connected object produces energy from solar energy or wind.

In one particular embodiment, an action is performed if the predicted operating duration is lower than a threshold, or does not allow the connected object to perform a programmed task, or if it does not allow the connected object to finish an ongoing task without this task being adapted.

In one particular embodiment, the action performed by the connected object comprises modifying an energy consumption mode of the connected object. The connected object may for example be put into sleep mode or switched off.

In one particular embodiment, the action performed by the connected object comprises saving data of the connected object.

In one particular embodiment, the action performed by the connected object comprises outputting or sending an alert indicating the predicted operating duration of the connected object.

In one particular embodiment, the action performed by the connected object comprises reprogramming a task programmed at a time when it is predicted that the connected object will fail, for example a computing task, for example a cryptographic computing task.

In one particular embodiment, the action performed by the connected object comprises adapting at least one parameter of an (established or future) communication between the connected object and at least one other equipment, for example a bit rate adaptation.

In one particular embodiment, in which two connected objects are communicating, a first connected object may obtain the predicted operating duration of the other connected object and take this duration into account in order to adapt at least one parameter of the communication.

In one particular embodiment, the prediction method according to the invention comprises a step of measuring the amount of consumed instantaneous energy.

In another particular embodiment, the amount of consumed instantaneous energy is obtained from successive measurements of the amount of energy stored in a battery of the connected object.

In another particular embodiment, the amount of consumed instantaneous energy is obtained from a measurement of the amount of consumed instantaneous energy, this measurement being correlated with successive measurements of the amount of energy stored in a battery of the connected object.

In one particular embodiment, the remaining service life of the connected object is obtained from a remaining service life in the absence of provision of energy, the remaining service life in the absence of provision of energy itself being obtained from an abacus indexed by the amount of energy stored in a battery and by the amount of consumed instantaneous energy.

The abacus may be created beforehand and stored in a memory of the connected object. It may also be created or updated by the connected object. It is highly advantageous to use such an abacus in the context of a connected object, since this makes it possible to obtain a reliable estimate of the service life of the connected object without any calculation, this estimate being obtained simply by reading the abacus.

In one particular embodiment, the amount of instantaneous energy able to be used to supply the connected object is the energy produced by the connected object from the ambient energy. This energy is measured at the output of an energy production module of the connected object.

However, the proposed method does not impose measuring the instantaneous energy produced by the connected object from the ambient energy.

In one particular embodiment, the connected object comprises a sensor for measuring the ambient energy, and the service life of the connected object is obtained from a measurement of the ambient energy and from an amount of instantaneous energy consumed by the connected object.

In this particular embodiment, the remaining service life of the connected object may be obtained from an abacus indexed by the measurement of the ambient energy and by the amount of consumed instantaneous energy.

In one particular embodiment, the amount of instantaneous energy able to be produced by the connected object is measured at the output of an energy production module of the connected object and correlated with a measurement of the ambient energy.

In one particular embodiment, the method comprises:
a step of recording/storing the predicted operating duration of the connected object at a current time; and
a step of estimating the predicted operating duration of the connected object at a given time on the basis of the history.

This embodiment makes it possible to predict the operating duration of the connected object without performing new measurements, based on the past. This embodiment is particularly advantageous when the connected object has regular or periodic operation.

In one particular embodiment, the amount of consumed instantaneous energy is measured. In another particular embodiment, not exclusive from the previous embodiment, the proposed method comprises:
a step of obtaining, for at least one task likely to be performed by the connected object, a profile of the instantaneous consumption of the connected object caused by performing the task;
a step of estimating the amount of consumed instantaneous energy based on a data structure of consumption profiles of tasks likely to be performed by the connected object.

One (or more) instantaneous consumption profile(s) of a task may be created beforehand and independently of the method performed by the connected object, and stored in a memory of the connected object. However, such a profile may also be created or updated by the connected object based on tasks performed at a given time and on the amount of energy consumed at this given time. This embodiment makes it possible to refine a consumption profile or to create one for a new task, for example.

In one particular embodiment, the proposed prediction method is implemented by a computer program.
An exemplary embodiment of the invention therefore also targets a computer program on a recording medium, this program being able to be implemented in a connected object or more generally in a computer. This program includes instructions designed to implement a prediction method as described above.

This program may use any programming language and be in the form of source code, object code or intermediate code between source code and object code, such as in a partially compiled form, or in any other desirable form.

An exemplary embodiment of the invention also targets a computer-readable information medium or recording medium including computer program instructions, such as mentioned above.

The information medium or recording medium may be any entity or device capable of storing the programs. For example, the media may include a storage means, such as a ROM, for example a CD-ROM or a microelectronic circuit ROM, or else a magnetic recording means, for example a floppy disk or a hard disk, or a flash memory.

Moreover, the information medium or recording medium may be a transmissible medium such as an electrical or optical signal, which may be routed via an electrical or optical cable, by radio link, by wireless optical link or by other means.

The program according to an exemplary embodiment of the invention may in particular be downloaded from an Internet network.

As an alternative, the information medium or recording medium may be an integrated circuit in which a program is incorporated, the circuit being designed to execute or to be used in the execution of one of the methods according to an exemplary embodiment of the invention.

### BRIEF DESCRIPTION OF THE DRAWINGS

Other features and advantages of the present disclosure will emerge from the description given below, with reference to the appended drawings which illustrate an exemplary embodiment thereof that is in no way limiting. In the figures:

FIG. 1 schematically illustrates a connected object in one particular embodiment;

FIG. 2 shows the main steps of a prediction method according to one particular embodiment, in the form of a flowchart;

FIG. 3 shows one example of a data structure of consumption profiles of tasks, able to be used in one particular embodiment;

FIG. 4 shows one example of a data structure associating amounts of ambient energy and amounts of energy produced, able to be used in one particular embodiment;

FIG. 5 shows one example of an abacus that makes it possible to estimate the service life of a connected object without and with provision of energy, in one particular embodiment;

FIG. 6 shows one example of a data structure storing a history of predictions of operating durations of a connected object, in one particular embodiment; and

FIG. 7 shows the functional architecture of a connected object in one particular embodiment.

### DETAILED DESCRIPTION OF SEVERAL EMBODIMENTS

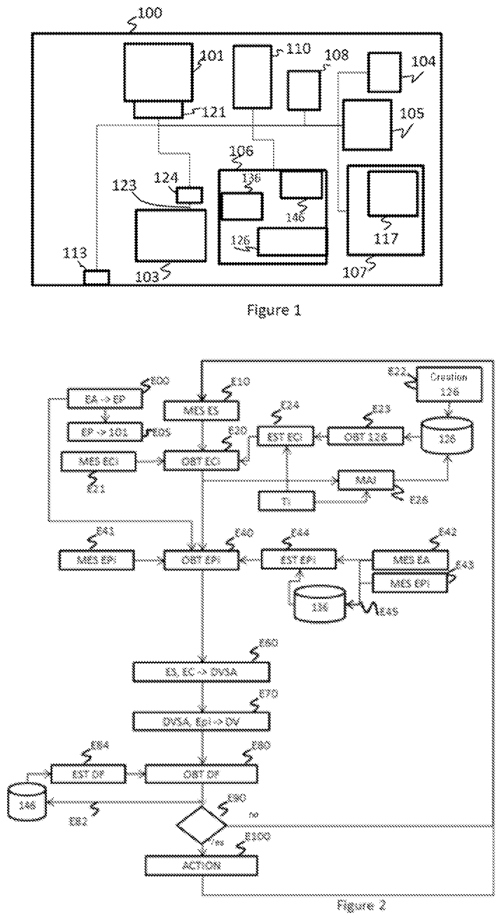

FIG. 1 shows a connected object 100 in one particular embodiment.

In this embodiment, the connected object 100 comprises a battery 101 supplied by photovoltaic panels 103, a rewritable non-volatile memory 106, a processor 104, an operating system 105, a read-only memory 107, a volatile memory 108 and a communication module 110.

In the embodiment described here, the battery 101 comprises a terminal or connector 121 from which it is possible to obtain an electric charge I_{B} of the battery 101 and an average voltage U_{B} at which this charge is supplied.

In the embodiment described here, the connected object comprises a sensor 113 for measuring an amount of ambient energy EA (expressed here in lux).

In the embodiment described here, the photovoltaic panels 103 comprise a unit 124 configured so as to obtain, from a terminal 123, an electric charge I_{P} and an average voltage U_{P} that make it possible to determine the amount of instantaneous energy EPi produced by the photovoltaic panels 103 from the ambient energy.

The sensor 113 and the unit 124 are two examples of modules according to an exemplary embodiment of the invention for obtaining an amount of instantaneous energy (specifically the ambient energy EA or the energy EPi produced from this ambient energy) able to be used directly or indirectly to supply the connected object 100.

If the ambient energy is solar energy, the sensor 113 may be a photoresistor or a brightness sensor. This sensor may possibly be integrated into the photovoltaic panel.

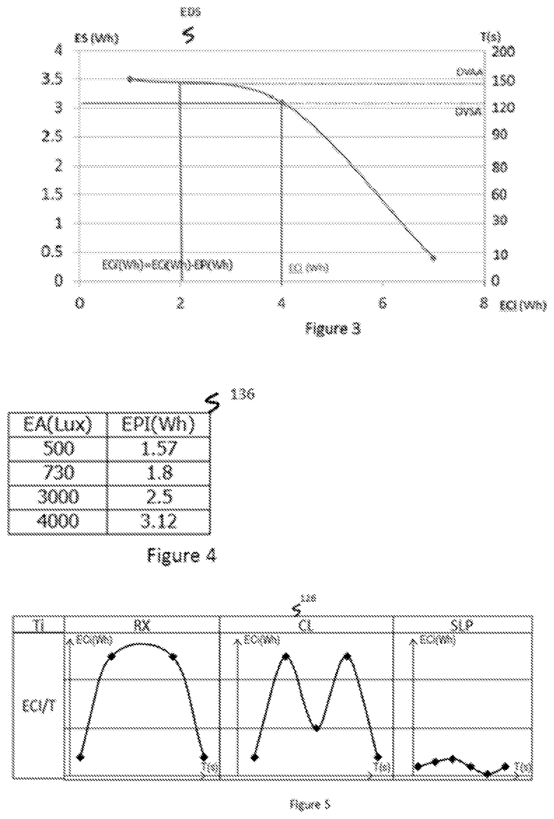

In the embodiment described here, the memory 106 comprises three data structures able to be accessed by the processor 104 in read mode and in write mode, specifically:
a data structure 126 shown in FIG. 3 containing consumption profiles of a certain number of tasks Ti that are able to be performed by the connected object 100;
a data structure 136 shown in FIG. 4 containing, for several ambient energy EA conditions, amounts of instantaneous energy EPi able to be produced by the photovoltaic cells 103 under these conditions;
a data structure 146 shown in FIG. 6 containing a history of the predictions of an operating duration DF of the connected object 100 at various times.

The memory 107 stores a computer program 117 able to be read by the processor 104 and configured so as to perform a method for predicting the operating duration DF, the main steps of which are shown in FIG. 2.

In the embodiment described here, the ambient energy EA is solar energy.

As a variant, the battery 101 may be supplied by a renewable energy source other than solar energy, for example energy produced through a technique using wind or water, or any other type of renewable energy (for example a technique using a temperature difference, radio waves, etc.).

The module for obtaining an amount of instantaneous energy dependent on the ambient energy and able to be used to supply the connected object (for example the unit 124 and the terminal 113) depends on the type of renewable energy. When several renewable energies are used, several modules may be used, each suited to one type of renewable energy.

The battery 101 may also be supplied by an electricity grid.

In the embodiment described here, the battery 101 is a supercapacitor, but any other type having similar operation may be used.

At least one of the data structures 126 (consumption profiles of the tasks) or 136 (produced and ambient energies) may be created beforehand and loaded into the non-volatile memory 106, or even into the read-only memory 107 if these structures are not intended to be subsequently updated.

In the embodiment described here, the data structures 126 or 136 are created and updated in accordance with the prediction method.

In particular, the data structure 126 of consumption profiles of tasks illustrated in FIG. 3 is created (step E22) and updated (step E26) by the processor 104 based on: (i) knowledge of the tasks Ti executed at a given time by the processor 104, and (ii) the amount of instantaneous energy consumed by the connected object 100 at this time. In the embodiment described here, the active tasks Ti are communicated to the processor 104 by the operating system 105.

In the example of FIG. 3, the data structure 126 contains the profile of a reception RX task Ti, that of a computing CL task Ti and the energy profile consumed in sleep mode SLP.

In the embodiment described here, the data structure 136, shown in FIG. 4, which associates an amount of instantaneous energy EPi produced by the photovoltaic cells, on the basis of the ambient energy EA, may be updated by the processor 104, for example on the basis of a value of the ambient energy EA obtained (step E42) by the sensor 113 and of an amount of instantaneous energy EPi produced at the same time by the photovoltaic panels 103 and obtained by the unit 124 from the terminal 123.

By way of example, the structure 136 shown in FIG. 4 contains a record indicating that the photovoltaic panels 103 produce an instantaneous energy EPi of 1.57 watt-hours (Wh) for an ambient energy of 500 lux.

In the embodiment described here, the data structure 146 that stores the history of the predictions of the operating durations DF is updated (step E82) by recording, in this structure, an operating duration DF of the connected object 100 as predicted at a current time IC.

By way of example, according to the data structure shown in FIG. 6, it was predicted at 12:05 that the connected object 100 would have an operating duration DF of 15 minutes.

FIG. 2 shows the main steps of a method for predicting an operating duration DF of the connected object 100, according to one particular embodiment, in the form of a flowchart.

In the example described here, this method is performed when the processor 104 executes the computer program 117.

In the embodiment described here, this method comprises a step E10 of obtaining an amount of energy ES stored in the battery 101 on the basis of the average voltage U_B and of the electric charge I_B read at the terminal 121.

The amount of stored energy ES is equal to the electric charge of the battery 101 I_{B} in ampere-hours (Ah) multiplied by the average voltage U_{B} in volts (V) at which this charge is discharged.

The amount of stored energy ES may be measured in watt-hours (Wh) using the formula:

ES(Wh)=I_{B}(Ah)*U_{B}(V)

The method comprises a step E20 of obtaining an amount of instantaneous energy ECi consumed by the connected object 100. This amount of consumed instantaneous energy ECi may be obtained in several ways.

In a first variant, this amount ECi is obtained through a difference between the measurements of energy ES stored in the battery 101 between two times t-1 and t that are close enough:

ECi(Wh)=ESt(Wh)−ESₜ₋₁(Wh)

In a second variant, in addition or not in addition to the first variant, the amount of consumed instantaneous energy ECi is obtained in the data structure 126 from tasks Ti currently being executed by the processor 104, the list of these tasks Ti being communicated to the processor 104 by the operating system 105 in this same step.

In the embodiment described here, the photovoltaic cells produce an energy EP from an ambient energy EA (general step E00), this produced energy being stored in the battery 101 in a general step (E05).

In the embodiment described here, according to the method, in a step E40, the amount of instantaneous energy EPi able to be produced by the photovoltaic panels is obtained. This amount EPi may be obtained in several ways.

In a first variant, the method according to an exemplary embodiment of the invention comprises a step E41 of obtaining the amount of instantaneous energy EPi produced by the photovoltaic panels 103 on the basis of the average voltage U_{P} and of the electric charge I_{P} read at the terminal 113.

The amount of produced instantaneous energy EPi may be measured in watt-hours (Wh) using the formula:

EPi(Wh)=I_{P}(Ah)*U_{P}(V)

In a second variant, in addition or not in addition to the first variant, the amount of produced instantaneous energy EPi is read in the data structure 136 based on a measurement E42 of the amount of ambient energy, taken by the sensor 123.

In a third variant embodiment, just the ambient energy EA is measured, and not the amount of produced energy EPi produced by the connected object from the ambient energy.

Steps E10 to E45 have made it possible to describe how, in various embodiments of the invention, it is possible to obtain:

an amount of energy ES stored in the battery 101; and/or
an amount of instantaneous energy ECi consumed by the connected object 100; and/or
an ambient energy EA; and/or
an amount of instantaneous energy EPi able to be produced by the photovoltaic cells 103; from the ambient energy.

According to the chosen embodiment and as described below, one or more of these energies ES, ECi, EPi, EA are used to obtain a predicted operating duration DF of the connected object 100.

In one particular embodiment, the remaining service life DV of the connected object is obtained from an abacus indexed by the measurement of the ambient energy and by the amount of consumed instantaneous energy.

In another embodiment, the amount of stored energy ES and the amount of consumed instantaneous energy ECi are used in a step E60 to obtain a remaining service life DVSA of the connected object 100 without provision of energy.

This remaining service life without provision of energy DVSA of the connected object 100 does not take into account the amount of instantaneous energy EPi produced by the photovoltaic cells.

In the embodiment described here, the remaining service life DVSA without provision of energy is obtained, as shown in FIG. 5, by reading an abacus indexed by the amount of stored energy ES and by the amount of consumed instantaneous energy ECi.

Thus, in the example of FIG. 5, it may be estimated, if the amount of energy ES stored in the battery 101 is 3.1 Wh and if the amount of instantaneous energy ECi consumed by the connected object 100 is 4 Wh, that the remaining service life DVSA of the connected object without provision of energy is 125 seconds.

In one embodiment, in a step E70, the remaining service life DV of the connected object 100 is obtained from the remaining service life, DVSA, of the connected object 100 without provision of energy, and from the amount of instantaneous energy able to be produced EPi.

In the embodiment described here, the remaining service life DV is obtained from the abacus in FIG. 5 that has already been described, taking into account the amount of produced instantaneous energy EPi.

This operation may be performed considering that the amount of produced instantaneous energy EPi is deducted from the amount of consumed instantaneous energy ECi, so as to define a corrected amount of consumed instantaneous energy, denoted ECi′.

Thus, by way of example, in the abacus in FIG. 5, for an amount of energy ES stored in the battery 101 equal to 3.1 Wh, an amount of instantaneous energy ECi consumed by the connected object 100 equal to 4.5 Wh, and an amount of produced instantaneous energy EPi equal to 2.5 Wh, it is possible to estimate that the remaining service life DV of the connected object is 145 seconds, since the corrected amount of consumed instantaneous energy ECi′ is equal to 2 Wh.

With continuing reference to FIG. 2, the method comprises a step E80 of obtaining the predicted operating duration, DF, of the connected object 100.

In the embodiment described here, the predicted operating duration DF of the connected object 100 is the remaining service life DV of the connected object as obtained in step E70.

In another embodiment, the predicted operating duration DF of the connected object 100 is estimated, as shown in FIG. 6, on the basis of the data structure 146, this having been updated during previous instances of step E80.

By way of example, assuming, with reference to FIG. 6, that the current time IC is 12:25, it may be estimated, through simple interpolation based on the data structure 146, that the operating duration of the connected object at 12:25 is 7 minutes, since it is apparent from this structure that the predicted service life decreases by 2 minutes every 5 minutes.

Such an estimate may be made for example using mathematical calculations or using an artificial intelligence model.

Steps E60 to E84 disclosed above have made it possible to describe various embodiments of the method, making it possible to obtain a predicted operating duration DF of the connected object 100.

This predicted operating duration DF thus makes it possible to predict a time of failure of the connected object, and this is taken into account in order to perform an action.

Returning to FIG. 2, after step E80 of obtaining the predicted operating duration DF of the connected object, the method according to an exemplary embodiment of the invention comprises a test E90 for determining whether at least one action should be performed on the basis of the predicted operating duration DF of the connected object.

By way of example, and without limitation, an action is performed if the predicted operating duration DF:
is lower than a defined threshold; or
does not allow the connected object to perform a programmed task; or
does not allow the connected object to finish an ongoing task without this task being adapted.

If the result of the test E90 is positive, an action is performed in step E100. Depending on the chosen embodiment, the action performed by the connected object may comprise:

modifying an energy consumption mode of the connected object 100. The connected object 100 may for example be put into sleep mode or switched off; and/or
saving the data contained in the volatile memory 108 of the connected object, in its non-volatile memory 106; and/or
outputting or sending an alert indicating the operating duration DF of the connected object 100; and/or
reprogramming a task programmed at a time when it is predicted that the connected object will fail, for example a computing task, such as a cryptographic computation; and/or
adapting at least one parameter of an (established or future) communication between the connected object and at least one other equipment, for example a communication bit rate adaptation.

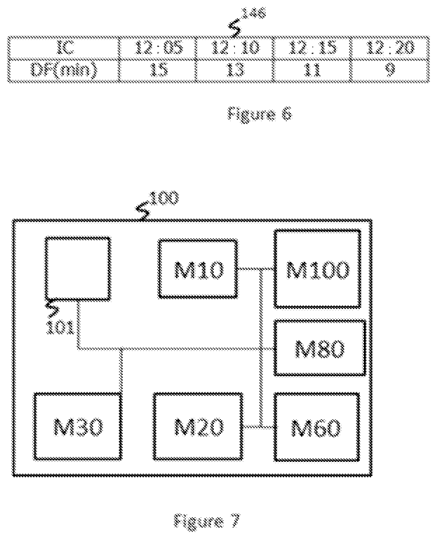

FIG. 7 shows, in one particular embodiment, the functional architecture of the connected object 100 from FIG. 1. According to this architecture, the connected object comprises:

a module M10 for measuring an amount of energy ES stored in the battery 101;

a module M20 for obtaining an amount of instantaneous energy ECi consumed by the connected object;

a module M30 for obtaining an amount of instantaneous energy dependent on the ambient energy and able to be used to supply the connected object. This module M30 may comprise a sensor 113 able to measure the ambient energy EA and/or a unit 124 able to measure, at the terminal 123, an amount of energy produced by the photovoltaic panels 103;
a module M60 for obtaining a predicted remaining service life of the battery 101;
a module M80 for obtaining an operating duration DF of the connected object; and
a module M100 for performing at least one action taking into account the operating duration DF.

These modules may be based on data structures such as those described above with reference to FIGS. 3, 4 and 6 (126, 136, 146).

The embodiments have been described for a connected object comprising a battery. Other embodiments may be derived therefrom when the connected object does not comprise a battery.

Although the present disclosure has been described with reference to one or more examples, workers skilled in the art will recognize that changes may be made in form and detail without departing from the scope of the disclosure and/or the appended claims.

What is claimed is:

1. A method for predicting an operating duration of a connected object, the method being implemented by the connected object and comprising:
obtaining an amount of instantaneous energy consumed by the connected object;
obtaining at least one amount of instantaneous energy dependent on an ambient energy, and able to be used to supply said connected object;
obtaining a remaining service life of the connected object on the basis of said amounts;
obtaining said predicted operating duration of the connected object on the basis of said remaining service life; and
performing at least one action taking into account said predicted operating duration.

2. The method as claimed in claim 1, comprising measuring said amount of consumed instantaneous energy.

3. The method as claimed in claim 1, wherein said amount of consumed instantaneous energy is obtained from successive measurements of an amount of energy stored in a battery.

4. The method as claimed in claim 3, wherein said remaining service life of the connected object is obtained from a remaining service life in the absence of provision of energy, said remaining service life in the absence of provision of energy being obtained from an abacus indexed by said amounts of consumed instantaneous energy and stored energy.

5. The method as claimed in claim 1, wherein said amount of instantaneous energy able to be used to supply said connected object is measured at the output of an energy production module of said connected object.

6. The method as claimed in claim 4, comprising:
measuring said ambient energy;
the service life of the connected object being determined based on said measurement of the ambient energy and on said amount of instantaneous energy consumed by the connected object.

7. The method as claimed in claim 1, comprising:
recording said predicted operating duration and a current time in a history; and
estimating said predicted operating duration at a given time on the basis of said history.

8. The method as claimed in claim 1, comprising:
obtaining, for at least one task likely to be performed by said connected object, a profile of the instantaneous consumption of said connected object caused by performing said task;
estimating said amount of consumed instantaneous energy based on a data structure of consumption profiles of tasks likely to be performed by said connected object.

9. The method as claimed in claim 8, wherein said profile is created or updated based on tasks performed by said connected object at a given time and on said amount of instantaneous energy consumed at said given time.

10. The method as claimed in claim 1, wherein said action comprises adapting at least one parameter of a communication between said connected object and at least one or other equipment on the basis of said predicted operating duration.

11. The method as claimed in claim 1, wherein said action comprises outputting an alert indicating said predicted operating duration.

12. The method as claimed in claim 1, wherein said action comprises modifying an energy consumption mode of said connected object.

13. The method as claimed in claim 1, wherein said action comprises saving data of said connected object.

14. A connected object comprising:
a processor; and
a non-transitory computer-readable medium comprising instructions stored thereon which when executed by the processor configure the connected object to:
obtain an amount of instantaneous energy consumed by the connected object;
obtain at least one amount of instantaneous energy dependent on an ambient energy and able to be used to supply said connected object;
obtain a remaining service life of said connected object on the basis of said amounts;
obtain a predicted operating duration of said connected object on the basis of said remaining service life; and
perform at least one action taking into account said predicted operating duration.

15. A non-transitory computer-readable medium comprising a computer program stored thereon containing instructions configured so as to implement a method for predicting an operating duration of a connected object when the instructions are executed by a processor of the connected object, wherein the instructions configure the connected object to:
obtain an amount of instantaneous energy consumed by the connected object;
obtain at least one amount of instantaneous energy dependent on an ambient energy and able to be used to supply said connected object;
obtain a remaining service life of said connected object on the basis of said amounts;
obtain a predicted operating duration of said connected object on the basis of said remaining service life; and
perform at least one action taking into account said predicted operating duration.
